(19) United States
(12) Patent Application Publication
(10) Pub. No.: US 2024/0400129 A1
(43) Pub. Date: Dec. 5, 2024

(54) ZERO TURN STEERABLE FRONT END WITH SINGLE MOTOR

(71) Applicant: MTD PRODUCTS INC, Valley City, OH (US)

(72) Inventors: Michael Gretchko, North Ridgeville, OH (US); Adam Hiller, Jeromesville, OH (US)

(21) Appl. No.: 18/677,225

(22) Filed: May 29, 2024

Related U.S. Application Data
(60) Provisional application No. 63/470,624, filed on Jun. 2, 2023.

(51) Int. Cl. B62D 5/04; B62D 7/15

(52) U.S. Cl. CPC B62D 5/046; B62D 7/1509

(57) ABSTRACT

A single motor steering system is disclosed. One example embodiment is a steering system, comprising: first and second steerable wheels coupled to first and second wheel gears, respectively; a controller that generates a motor control signal based on an input signal; a steering motor configured to rotate a driven steering gear based on the motor control signal, wherein the driven steering gear is mechanically linked to a linked steering gear configured to rotate with the driven steering gear, wherein the driven steering gear is coupled to the first wheel gear such that rotation of the driven steering gear rotates the first wheel gear and the first steerable wheel to a first angle, and wherein the linked steering gear is coupled to the second wheel gear such that rotation of the linked steering gear rotates the second wheel gear and the second steerable wheel to a second angle.

### CROSS-REFERENCE TO RELATED APPLICATIONS

This application claims the benefit of U.S. Provisional Application No. 63/470,624, filed Jun. 2, 2023. The latter application and the following applications are hereby incorporated by reference within the present disclosure in their respective entireties and for all purposes: U.S. Provisional Patent Application No. 60/701,716, filed Jul. 22, 2005, U.S. Provisional Patent Application No. 60/710,231, filed Aug. 22, 2005, U.S. Provisional Patent Application No. 60/731,593, filed Oct. 28, 2005, and U.S. patent application Ser. No. 11/490,881, filed Jul. 21, 2006.

### FIELD OF DISCLOSURE

This application relates generally to outdoor power equipment, and more specifically to steerable non-drive wheels controllable by a single motor, and employable for low- to zero-radius turns in connection with outdoor power equipment.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Many outdoor power equipment employ dummy caster wheels, which can support a non-driven end of the outdoor power equipment (e.g., front) while allowing for steering via drive elements (e.g., drive wheels rotated at different speeds to turn the outdoor power equipment, etc.). Unlike fixed wheels, casters can rotate their orientation to appropriate angles whether the power equipment is turning or driving straight. However, in some situations, dummy caster wheels can lead to undesirable behavior. For example, when attempting to drive straight along the side of a hill, gravity will cause the caster wheels to rotate away from the proper alignment for driving straight, making steering extremely difficult.

### SUMMARY

The following presents a simplified summary in order to provide a basic understanding of some example aspects of the disclosure. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

According to one aspect, an example vehicle is disclosed. The example vehicle comprises: a frame; two drive elements coupled to the frame, wherein the two drive elements are configured to be driven independently of each other; steering controls configured to receive an operator input; a steering system configured to receive an input signal based at least in part on the operator input, comprising: a first steerable wheel coupled to a first wheel gear and a second steerable wheel coupled to a second wheel gear; a steering motor controller configured to receive the input signal and to generate a motor control signal based on the input signal; a steering motor configured to rotate a driven steering gear based on the motor control signal, wherein the driven steering gear is mechanically linked to a linked steering gear such that the linked steering gear is configured to rotate with the driven steering gear, wherein the driven steering gear is coupled to the first wheel gear such that rotation of the driven steering gear rotates the first wheel gear and the first steerable wheel to a first angle, and wherein the linked steering gear is coupled to the second wheel gear such that rotation of the linked steering gear rotates the second wheel gear and the second steerable wheel to a second angle.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 is a perspective view of an example lawn maintenance apparatus that can comprise embodiments discussed herein.

FIG. 2 illustrates first example positions of steerable, ground-engaging front wheels of an embodiment associated with a non-zero turning radius turn, according to various aspects discussed herein.

FIG. 3 illustrates second example positions of steerable, ground-engaging front wheels of an embodiment associated with a non-zero turning radius turn, according to various aspects discussed herein.

FIG. 4 illustrates an example embodiment of a drive-by-wire steering system that employs a single motor to operate a plurality of steerable wheels, in accordance with various aspects discussed herein.

FIG. 5 illustrates a diagram showing a first example embodiment of a single motor steering system employable in a vehicle, according to various aspects discussed herein.

FIGS. 6A-C illustrates views of an example gear pair employable in connection with a steerable wheel, according to various aspects discussed herein.

FIGS. 7A-C illustrates views of another example gear pair employable in connection with a steerable wheel, according to various aspects discussed herein.

FIG. 8 illustrates a block diagram of an example control unit operable in conjunction with one or more aspects of the present disclosure.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to providing a single motor steering system capable of low- and/or zero-radius turning are described herein, it should be understood that the disclosed machines, electronic and computing devices and methods are not so limited and modifications may be made without departing from the scope of the present disclosure. The scope of the systems, methods, and electronic and computing devices for providing single-motor steering capable of low- and/or zero-radius turning are defined by the appended claims, and all devices, processes, and methods that come within the meaning of the claims, either literally or by equivalence, are intended to be embraced therein.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating the same elements.

Various embodiments relate to vehicles that are capable of making a low- to zero-radius turn (e.g., a small radius turn) using a pair of non-driving wheels (in some embodiments, the driving wheels may also be capable of being turned) that can be steered by a single motor to appropriate angles for low- or zero-radius turns based on operator input via a steering input device (e.g., steering wheel, joystick, jogwheel, etc.).

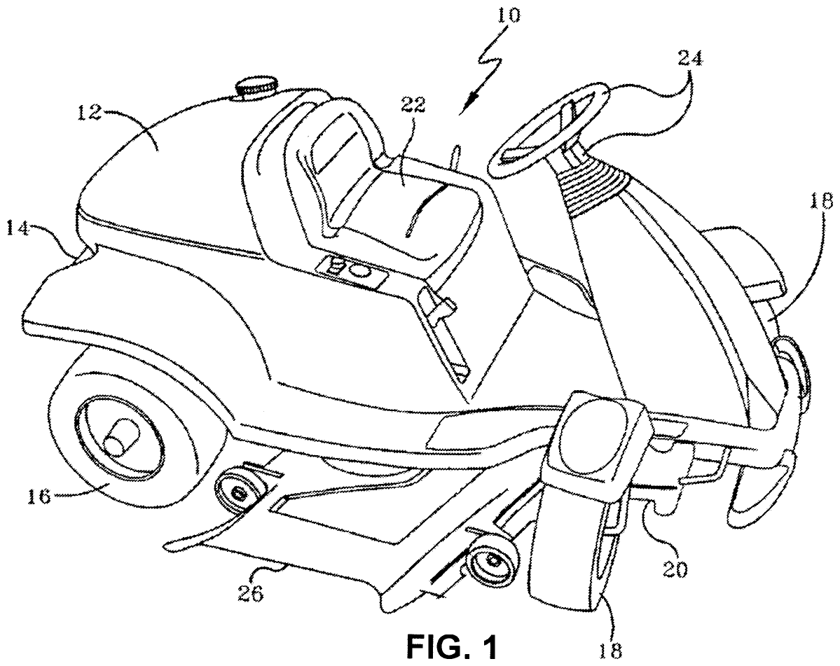

Referring to FIG. 1, illustrated is an example lawn maintenance vehicle 10, one example of an outdoor power equipment that can employ embodiments discussed herein. The vehicle 10 includes a prime mover 12 (e.g., an engine, one or more batteries, etc.) that is mounted to a structural frame or chassis 14. The vehicle 10 includes drive elements 16 (e.g., wheels, tracks, etc.), such as left and right rear drive wheels that are coupled to the frame 14. The drive elements 16 are operatively coupled to the prime mover 12, such as through a transmission system, one or more electrically powered motors, hydraulic/hydrostatic means, etc., to provide locomotion to the vehicle 10. The vehicle 10 also has steerable structure(s) 18, such as right and left front ground-engaging wheels, which may be non-driving wheels. Other embodiments of the vehicles have only one steerable structure (e.g., three-wheeled all-terrain vehicles). Furthermore, in some embodiments, steerable structures such as skis may be used instead of wheels.

The chassis 14 supports an operator station comprising a seat 22 (although various embodiments can also be employed on vehicles operated while standing, etc.). Vehicle 10 also includes a mower deck 26, which can be mounted to the vehicle 10 in any of a variety of manners. Although vehicle 10 is shown as one example, various embodiments can be employed on other types of vehicles, including but not limited to utility vehicles, off road vehicles, tractors, golf carts, automobiles, etc.

The front wheels 18 are coupled to the frame of the vehicle through a pivotable connection to a front axle (not shown in FIG. 1) mounted on the chassis 14. The front wheels 18 are also coupled to a drive-by-wire steering system 20, which is configured to control the direction they turn as discussed more fully below. In the embodiment of the present vehicles shown in the figures, the front wheels are the steerable wheels 18 and the rear wheels are the drive wheels 16. However, one skilled in the art will understand that the rear wheels may be the steerable wheels and the front wheels may be the drive wheels in various embodiments. Likewise, the front wheels may be both the steerable wheels and the drive wheels.

A steering input device 24 (which is part of the embodiment of the steering system 20 shown in the figures) and a speed input device that controls the speed of vehicle 10 (not shown in FIG. 1) are located near the seat 22 (FIG. 1) so that they are accessible to the operator of the vehicle. An operator may apply a steering input to the steering input device 24, which transfers the steering input to other portions of the steering system 20. In the embodiment shown in FIG. 1, steering input device 24 is a steering wheel; however, in various embodiments the steering input device 24 may be another suitable steering device, including, but not limited to, a steering rod or joystick (not shown). An operator can control the speed and direction of the vehicle 10 by manipulating the steering input device 24 and the speed input device, which transmit the steering and speed inputs received from the driver to, respectively, the remainder of the steering system 20 and a speed system 29 that controls rotation of the drive wheels, which can vary depending on the embodiment (e.g., one or more motors, transmissions, hydraulic/hydrostatic means, etc.).

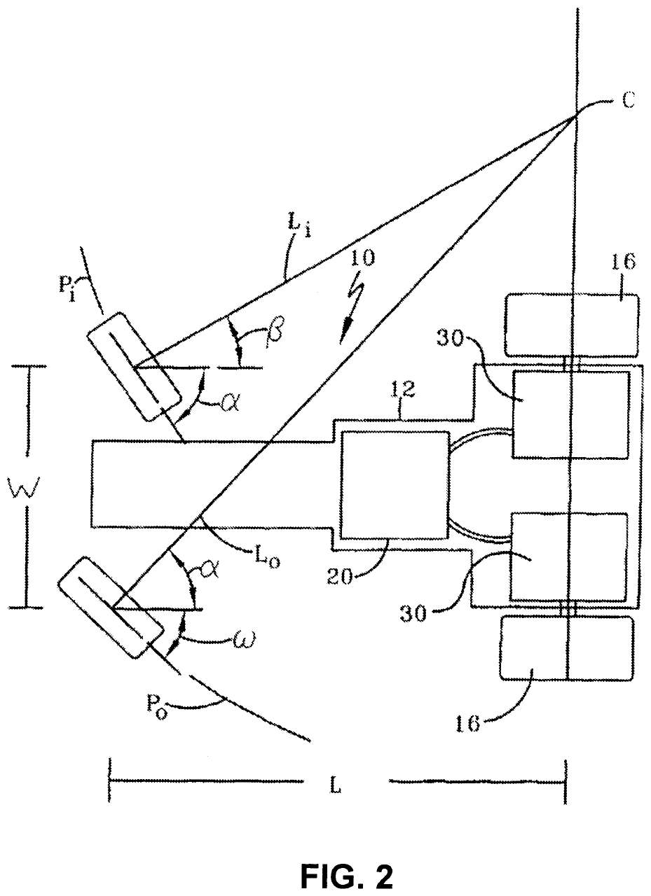

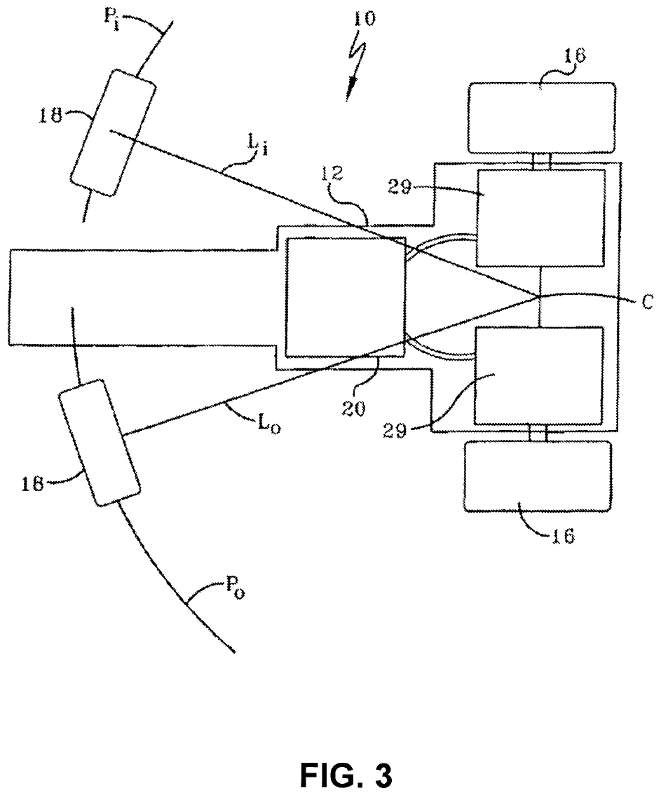

In the embodiment of vehicle 10 shown in FIG. 1, the right and left drive wheels 16 are coupled to chassis 14 such that their direction is fixed and their rotational axes are in constant alignment. In contrast, the front steerable wheels 18 are coupled to the chassis 14 in a way that gives them the ability to change direction. FIGS. 2 and 3 are schematic top views of the vehicle 10 illustrating that it possesses the ability to achieve substantially true Ackermann steering. FIG. 2 shows a non-zero radius turn, and FIG. 3 shows a zero-radius turn. When front wheels 18 make the turn depicted in FIG. 2, they take two distinct arc-like paths Pᵢ and Pₒ, which ideally will have a common center point C located along the axis that extends through the center of both drive wheels 16. Lines Lᵢ and Lₒ extend from center point C and intersect the paths Pᵢ and Pₒ, respectively, of the two wheels at the rotational centers of the wheels. The use of a substantially-true Ackermann steering geometry (which can be achieved using various embodiments discussed herein) can help to avoid scrubbing rubber from the tire tread on the outboard wheel or damaging vegetation under the front wheels.

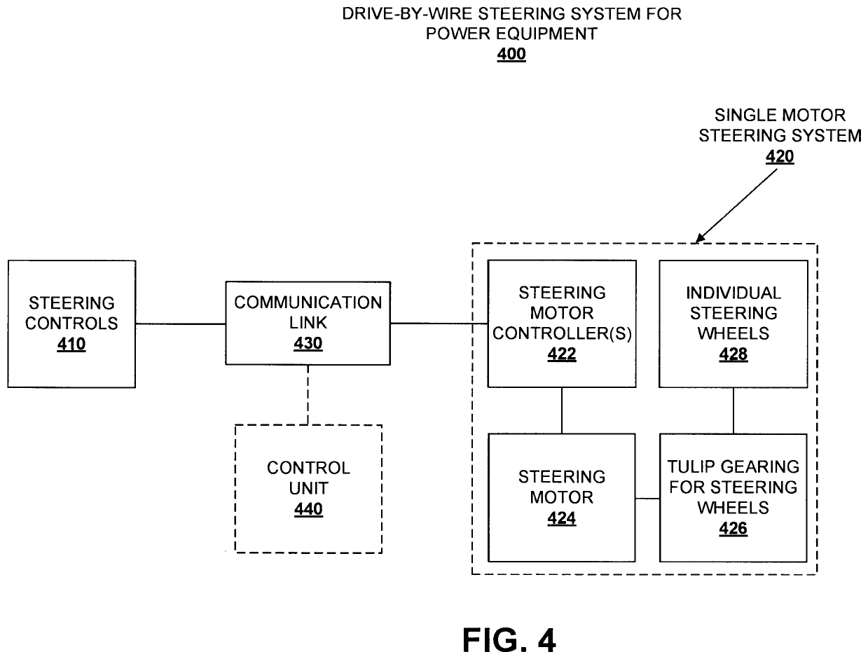

Aspects of steering system 20 are depicted in, e.g., FIGS. 4-7C. The steering system 20 couples inputs received via the steering input device 24 (e.g., as determined by a position encoder, etc.) to the front steerable wheels 18 (e.g., via a motor (e.g., motor 424, motor 510, etc.) controlling the angles of wheels 18, etc.) to aid in guiding vehicle 10. The steering assembly 20 is configured to control the steering system 20 to turn the vehicle 10, whether in large radius turns or in low- or zero-radius turns based on inputs received from a steering input device such as a steering wheel, etc. In some aspects, as discussed herein, steering system 20 can also provide a steering input to a control unit (e.g., control unit 440, etc.), which can coordinate that steering input with a speed input received through the speed input device 28.

Input(s) (e.g., rotation, displacement, etc.) by an operator can be received by steering system 20 via the steering input device 24. Considering an example employing a steering wheel as the steering input device 24, an angle of rotation can be determined (e.g., based on a current angular position and a defined zero angle, which can be either a fixed angular position or one redefinable as discussed herein, etc.). Based on the angle of rotation and potentially other factors (e.g., a speed of vehicle 10, a ratio between inputs and output that can be one of fixed or variable (e.g., based on speed (e.g., with less responsive steering at higher speed, such that a greater input is required for the same output) user preference, etc.), etc.), a motor can be controlled to rotate the steerable wheels (e.g., wheels 18) with a direction and amount that depends on the operator input (and potential other factors).

Referring to FIG. 4, illustrated is an example embodiment of a drive-by-wire steering system 400 that employs a single motor to operate a plurality of steerable wheels, in accordance with various aspects discussed herein. System 400 can be employed in a variety of vehicles, including outdoor power equipment, e.g., vehicle 10.

Steering controls 410 can be any of a variety of input devices that can receive operator inputs based on which a steering angle can be chosen, including steering input device 24 and any variations thereof discussed herein. Inputs from steering controls 410 can be communicated to a single motor steering system 420 over a communication link 430 (e.g., Controller Area Network (CAN) Bus, etc.). In some embodiments, system 400 can comprise a control unit 440 that can receive operator inputs from steering controls 410 and can generate a signal based on those inputs (and potentially other information, e.g., a vehicle speed, etc.) for single motor steering system 420 that can thereby control the angle(s) for the steerable wheels 428 (e.g., wheels 18, etc.).

In single motor steering system 420, a steering motor controller 422 is configured to receive signal(s) via communication link 430 from either steering controls 410 or control unit 440. Based on the received signal(s), controller 422 is configured to control a steering motor 424 to rotate the individual steerable wheels 428. This can be accomplished via motor 424 moving tulip gearing 426 that mechanically links the steerable wheels 428 such that they can be rotated to appropriate angles. In various embodiments, tulip gearing 426 can link steerable wheels 428 such that they can be rotated to combinations of angles appropriate for substantially-true Ackermann steering geometry.

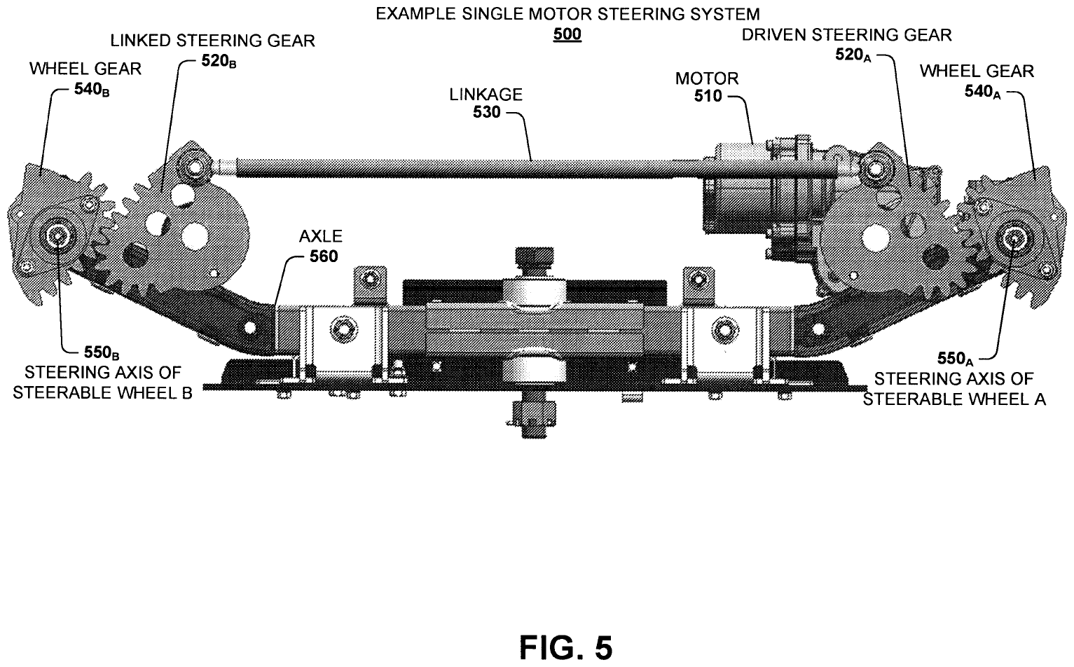

Referring to FIG. 5, illustrated is a diagram showing a first example embodiment of a single motor steering system 500 employable in a vehicle, according to various aspects discussed herein. In single motor steering system 500, a motor controller (not shown in FIG. 5, but see controller 422) can receive inputs based at least in part on operator inputs (e.g., from steering input device 24, steering controls 410, etc.), and can control motor 510 to rotate (e.g., in a given direction and through a given angle) based on the received inputs. Rotation of motor 510 can cause rotation of steering gears 520A and 520B, and thus wheel gears 540A and 540B, as follows. Motor 510 can rotate driven steering gear 520A, which can be mechanically linked to the shaft of motor 510 (e.g., directly, via gearing, etc.). Teeth of driven steering gear 520A are coupled to one or more teeth of wheel gear 540A, which is coupled to a steering axis 550A of a first steerable wheel, such that rotation of wheel gear 540A rotates the plane of rotation of the first steerable wheel. Driven steering gear 520A is mechanically linked (e.g., via a fixed length linkage 530 such as a panhard bar, etc.) to a linked steering gear 520B (which can be a mirror image of driven steering gear 520A), such that rotation of driven steering gear 520A causes a corresponding rotation in the same direction (e.g., clockwise or counterclockwise) of linked steering gear 520B. Similarly to driven steering gear 520A, teeth of linked steering gear 520B are coupled to one or more teeth of wheel gear 540B, which is coupled to a steering axis 550B of a second steerable wheel, such that rotation of wheel gear 540 rotates the plane of rotation of the second steerable wheel. Single motor steering system 500 can be attached to an axle 560 associated with the steerable wheels, and thereby mounted to the frame of a vehicle comprising system 500.

The linked rotation of the two steerable wheels resulting from system 500 can enable substantially true Ackerman steering geometry, allowing for a range of steering from straight to low- or zero-radius turning, depending on the input. As can be seen in FIG. 5, the illustrated gears are not circular, such that the gear teeth on gears 520A, 520B, 540A, and 540B are not all at the same distance from the axis of rotation of the gear, which results in a non-uniform gear ratio that depends on the angle of rotation. For example, on steering gears 520A and 520B, the upper teeth are at a relatively similar (compared to the lower teeth) radius from the rotational axis, while the lower teeth have a greater variation in radial distance (increasing and decreasing over the lower teeth) from the axis than the teeth adjacent to and above them. On gears 540A and 540B, the teeth decrease in radial distance from their axis as the radial distance of the teeth on the coupled steering gear increase, and then increase in radial distance from their axis as the radial distance of the teeth on the coupled steering gear decrease. As a result, for a right-hand turn, as gear 520A rotates counterclockwise (and 520B rotates counterclockwise), 540A rotates clockwise (and 540B rotates clockwise), and for a sufficient rotation (engaging the bottom teeth discussed above) gear 540A (and its corresponding wheel, the inner wheel on a right-hand turn) rotate faster and further than gear 540B (and its corresponding wheel), contributing to substantially true Ackermann steering geometry, such as shown in FIG. 3.

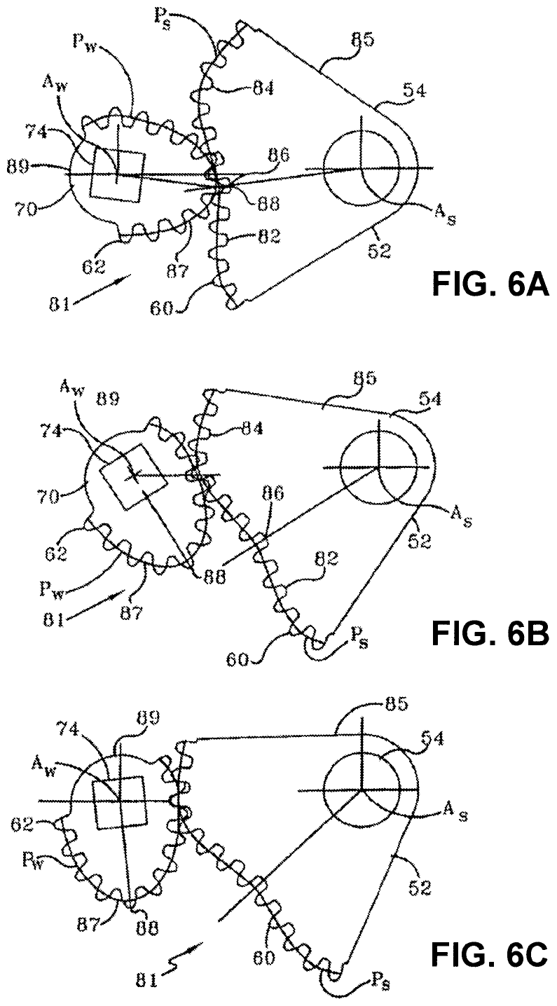

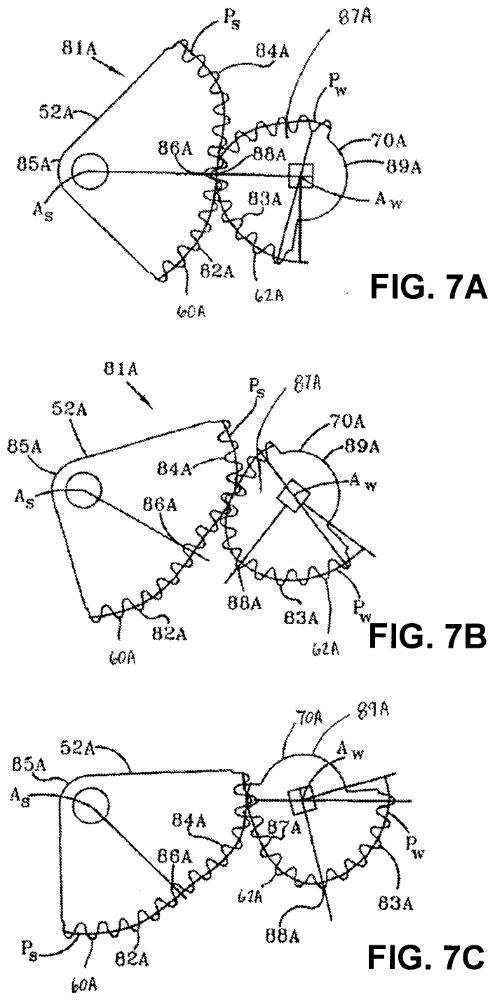

Other gear arrangements, as well as arrangements comprising additional or alternative components (e.g., belts, chains, etc.), besides those shown in FIG. 5 may be used for a single motor steering system. For example, FIGS. 6A-6C and 7A-7C, discussed below, show other non-circular gears that may be used for front wheel assemblies.

Turning now to FIGS. 6A-6C, in one embodiment, the steering (e.g., driven or linked) gear 52 and the wheel gear 70 combine to form a non-circular gear pair 81. In one embodiment, the steering gear 52 has a shape comprising two spline portions 82, 84 connected by a valley portion 86. As seen in FIG. 6A, the distance from pivot axis Aₛ of the steering gear 52 to the pitch line Pₛ of the steering gear 52 in the spline portions 82, 84 is greater than the distance from the pivot axis Aₛ, of the steering gear 52 to the pitch line Pₛ of the steering gear 52 in the valley portion 86. The rear portion 85 of the steering gear 52 can have any shape selected to accomplished the desired steering, such as the shape depicted in FIG. 6A. The wheel gear 70 has a substantially parabolic shaped portion 87 having a vertex 88. The rear portion 89 of the wheel gear 70 can have any shape selected to accomplish the desired steering, such as the shape depicted in FIGS. 6A-6C.

In the neutral or straight-ahead position, at least one or more of the teeth 62 near the vertex 88 of the parabolic portion 87 of the wheel gear 70 engage at least one or more of the teeth 60 in the valley portion 86 of the steering gear 52 as illustrated in FIG. 6A. Aₛ the steering gear 52 is rotated around its axis Aₛ, one of the spline portions 82, 84 engages the side of the parabolic portion 87 as the driven wheel gear 70 rotates around its axis A_{w}, as illustrated in FIGS. 6B and 6C.

In one embodiment, the spline portions 82, 84 of the steering gear have a different number of teeth. In the illustrated embodiment, the spline portion 82 has five teeth 60 and the spline portion 84 has seven teeth 60. The spline portion 84 has additional teeth 60 that extend further around the steering gear 52 on the side that engages the wheel gear 70 during an inward turn. The inward front wheel 18 turns through a greater angle than the outboard front wheel 18 to meet the Ackermann geometry. Accordingly, the spline portion 82 that engages the wheel gear 70 when making a turn on the outward side does not need as many teeth 60 because the outward front wheel 18 does not turn as far.

The non-circular shapes of the steering gear 52 and the wheel gear 70 (and, more specifically, the non-circular shapes of the toothed portions of the steering and wheel gears) enable the gear combination to have a non-uniform gear ratio. In the neutral position, the ratio of the distance between the pivot axis Aₛ, of the steering gear 52 to the pitch line Pₛ of the steering gear 52 to the distance between the pivot axis A_{w} of the wheel gear 70 and the pitch line P_{w} of the wheel curve can be between about 1.0:1.0 and 2.0:1.0, for example, about 1.5:1.0. In the extreme turning position illustrated in FIG. 6C, the ratio of the distance between the pivot axis Aₛ of the steering gear 52 to the pitch line Pₛ, of the steering gear 52 to the distance between the pivot axis A_{w} of the wheel gear 70 and the pitch line P_{w} of the wheel curve can be between about 2.0:1.0 and 4.0:1.0, for example, about 3.0:1.0. However, in various embodiments, other suitable gear ratios can be chosen. In some embodiments, the output of the gear ratio can range from 1.0:1.0 to 4.0:1.0, for example, from 1.5:1.0 to 3.0:1.0 as the gears rotate as shown in FIGS. 6A, 6B and 6C.

The non-uniform gear ratio of the gear pair permits the steering angle of the front wheels 18 to be responsive to the magnitude of the desired turn as determined by the input to the steering input device 24. When the vehicle 10 is traveling straight ahead or in a slight turn and the steering input device 24 is close to the neutral position, relatively small movements of the steering input device 24 can cause only relatively small changes in the angle of the front wheels 18. This enables the operator to travel in straight lines and precisely control the vehicle. On the other hand, when the operator desires to perform an extreme turn, it can be useful for the movement of the steering input device 24 to cause a relatively larger corresponding change in the steering angle of the front wheels 18. Accordingly, in some embodiments, the steering system 20 is configured such that movement of the steering input device 24 in a band around neutral (e.g., the plus or minus twenty degree range from neutral, or a larger or smaller band such as ranges from ±10° up to ±30°, a user customizable range, etc.) causes a relatively small change in the steering angle of the vehicle. In some embodiments, the size of the band can depend on a speed of the vehicle. However, when the steering input device 24 is turned for an extreme turn, such as a zero radius turn, the steering system (e.g., system 400) can increase the change in the steering angle so that the front wheels 18 rapidly reach the larger steering angle.

For example, some embodiments of the steering system (e.g., system 400) can be configured such that movement of the steering input device 24 to a position between about 10 degrees and about 20 degrees from the neutral position causes a corresponding change of the steering angle of the vehicle of between about 5 and about 20 degrees. In such embodiments, movement of the steering input (e.g., wheel, etc.) to a position between about 20 degrees and about 40 degrees from neutral causes a corresponding change of the vehicle steering angle of between about 20 and about 60 degrees. In such embodiments, movement of the steering wheel to a position between about 40 degrees and about 60 degrees from neutral causes a corresponding change of the steering angle of between about 60 and about 120 degrees. Dimensions of the steering and wheel gears of a given gear pair, such as the pitch lines, can be set so that the rotational axes of both front steerable wheels 18 are always made to intersect with the single point C on the rotational axis of drive wheels 16 to provide substantially true Ackermann steering.

FIGS. 7A-7C illustrate another embodiment of a non-circular gear pair 81A. This gear pair 81A has non-uniform pitch lines such that the shapes of the steering gear 52A and wheel gear 70A produce substantially true Ackermann steering geometry. This gear pair 81A may be used with various embodiments.

The steering gear 52A has a shape comprising two spline portions 82A, 84A connected at a juncture 86A. The spline portion 82A is engaged when the front wheel 18 to which the gear pair 81A is coupled is on the outboard side of the turn and the spline portion 84A is engaged when the front wheel 18 is on the inboard side of the turn. In the FIG. 7A embodiment, the distance from pivot axis Aₛ of the steering gear 52A to the pitch line Pₛ of the steering gear 52A in the spline portion 82A is substantially constant throughout the spline portion 82A, such that this portion of the steering gear 52A resembles a sector of a circle. However, the distance from pivot axis Aₛ of the steering gear 52A to the pitch line Pₛ is non-uniform in the spline portion 84A. Accordingly, the embodiment of steering gear 52A may be characterized as a non-circular gear, or as having a non-circular toothed portion.

In some embodiments, the distance from pivot axis Aₛ to pitch line Pₛ progressively increases to between about 110% and about 150% of the distance to the pitch line at the juncture 86A. In the illustrated embodiment, the distance from pivot axis Aₛ to the pitch line Pₛ near the teeth that engage the wheel gear 72A during an extreme inward turn is about 123% of the pitch line at the neutral position. The rear portion 85A of the steering gear 52A can have any suitable shape, such as the shape shown in FIG. 5.

The wheel gear 70A also has a non-uniform pitch line configured to match the pitch line of the steering gear 52A. In the illustrated embodiment, the wheel gear 72A has a first portion 83A in which the distance from the pivot axis A_{w} of the wheel gear 70A to the pitch line P_{w} of the wheel gear 70A is substantially constant throughout the portion 83A, such that this portion of the wheel gear 70A resembles a sector of a circle. The wheel gear 70A has a non-uniform portion 87A in which the distance from the pivot axis A_{w} of the wheel gear 70A to the pitch line P_{w} of the wheel gear 70A in the portion 87A is non-uniform. The uniform and non-uniform portions meet at a juncture 88A.

In the neutral or straight-ahead position, one or more of the teeth 62A near the juncture 88A of the wheel gear 70A engage one or more of the teeth 60A near the junction 86A of the steering gear 52A as illustrated in FIG. 7A. When making an inward turn as illustrated in FIGS. 7B and 7C, the steering gear 52A is rotated around the axis Aₛ such that the spline portion 84A engages the non-uniform side 87A of the wheel gear 70A as the wheel gear 70A rotates around axis A_{w}.

In some embodiments, the distance from pivot axis A_{w} to the pitch line P_{w} progressively decreases to between about 50% and about 75% of the distance at the juncture 88A. In the illustrated embodiment, the distance from pivot axis Aₛ to the pitch line Pₛ near the teeth that engage the wheel gear 72A during an extreme inward turn as shown in FIG. 7C is about 65% of the pitch line at the neutral position. The rear portion 89A of the wheel gear 70A can have any suitable shape, such as the shape shown in FIG. 5.

In one embodiment, the position of the teeth 60A, 62A and the pitch lines Pₛ and P_{w} for the steering gear 52A and wheel gear 70A are chosen so that substantially true Ackermann steering is provided by the gear pair 81A. One method of selecting the pitch lines Pₛ and P_{w} begins with determining the desired steering angles for the inside and outside front wheels 18. Referring back to FIG. 2, the inside wheel steering angle α and outside wheel steering angle ω can be determined using equation (1):

$$Tan ( 90 ° - ω ) ) = [ tan ( 90 ° - α ) - L - W ] / L \qquad ( 1 )$$

Using the desired steering angles, the pitch lines Pₛ and P_{w} may be set so that the rotational axes of both front steerable wheels 18 are always made to intersect with a single point C located on the rotational axis of drive wheels 16, as seen in FIGS. 2 and 3.

In the illustrated embodiment, the portions of the steering gear 52A and wheel gear 70A that engage each other when the gears are on the outside position of a turn (spline portion 82A and portion 83A) can have uniform pitch lines, while the portions of the gears that engage each other when the gears are on the inside position of the turn (spline portion 84A and portion 87A) can have non-uniform pitch lines. However, all portions of the gears can be non-uniform as long as the pitch lines Pₛ and P_{w} are selected to produce a substantially true Ackermann steering geometry for turning the front wheels 18.

The front wheel 18 on the inboard side of a turn steers through a greater steering angle than the outboard front wheel 18 in order to meet the Ackermann geometry. However, in the embodiment of the gear pair shown in FIGS. 7A-7C, the steering gears 52A on the inboard and outboard sides of the vehicle 10 will be rotated by the steering system at substantially the same speed and substantially the same magnitude. In some embodiments, the steering gear 52A is configured to rotate about 90 degrees, with about 45 degrees in the spline portion 82A and about 45 degrees in the spline portion 84A. The spline portion 84A has a longer pitch line than the spline portion 82A, and therefore more teeth. In the illustrated embodiment, the spline portion 82A has six teeth 60A and the spline 84A has seven teeth 60A. Similarly, the portion 87A of the wheel gear 70A must match its corresponding spline portion 84A on the steering gear 52A, so it also has a greater number of teeth 62A. Aₛ the pitch line P_{w} gets closer to the axis A_{w} in the portion 87A, the teeth 62A extend a greater distance around the circumference of the wheel gear 70A. Aₛ a result, the gear teeth 62A in the portion 83A take up a sector of between about 70 and 89 degrees and the gear teeth 62A in the portion 87A take up a sector of between about 91 and 120 degrees. The variation in the pitch lines between the inward turn side (84A, 87A) and the outward turn side (82A, 83A) causes the inward front wheel 18 to achieve a greater steering angle than the outward front wheel 18 in accordance with the Ackermann steering geometry.

The non-circular shapes of the steering gear 52A and the wheel gear 70A enable the gear combination to have a non-uniform gear ratio. In the neutral position, the ratio of the distance between the pivot axis Aₛ and pitch line Pₛ of the steering gear 52A to the distance between the pivot axis A_{w} and pitch line P_{w} of the wheel gear 70A can be between about 1.0:1.0 and 2.0:1.0, for example, about 1.5:1.0. The spline portion 82A of the steering gear 52A and the portion 83A of the wheel gear 70A have uniform pitch lines; therefore this ratio remains substantially constant for the front wheel 18 on the outboard side of the turn. However, in the extreme turning position illustrated in FIG. 7C, the ratio of the distance between the pivot axis Aₛ and the pitch line Pₛ of the steering gear 52A to the distance between the pivot axis A_{w} and the pitch line P_{w} of the wheel gear 70A for the front wheel on the inboard side can be between about 2.0:1.0 and 4.0:1.0, for example, about 3.0:1.0. However, any ratio suited to a given application may be chosen.

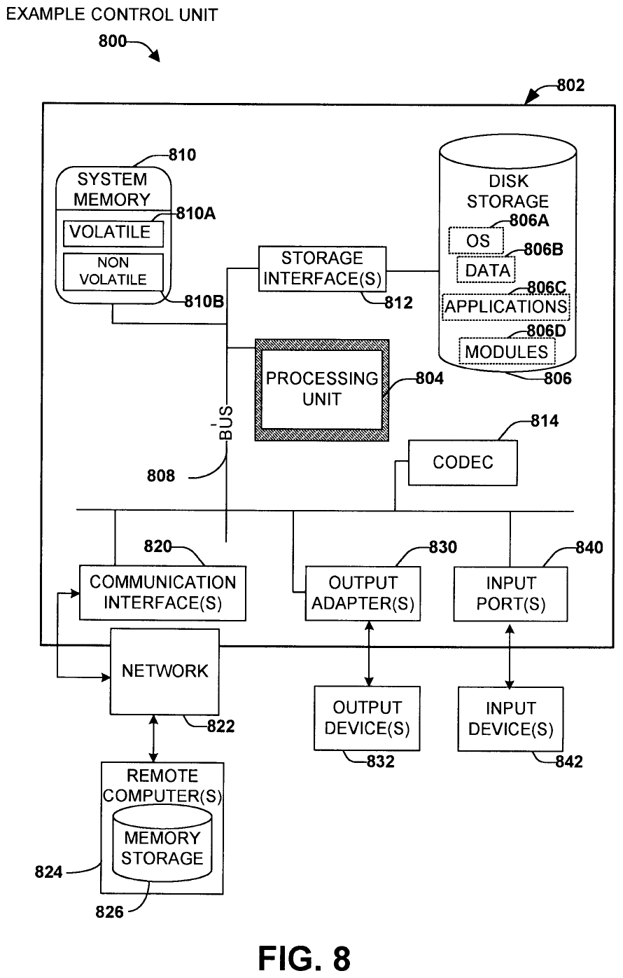

In connection with FIG. 8, the systems and processes described herein can be embodied within hardware, such as a single integrated circuit (IC) chip, multiple ICs, an application specific integrated circuit (ASIC), or the like. A suitable control unit 800 for implementing various aspects of the claimed subject matter includes a computer 802. In various embodiments, a control unit (e.g., control unit 440, etc.) of an outdoor power equipment can be embodied in part by computer 802, or an analogous computing device known in the art, subsequently developed, or made known to one of ordinary skill in the art by way of the context provided herein.

The computer 802 can include a processing unit 804, a system memory 810, a codec 814, and a system bus 808. The system bus 808 couples system components including, but not limited to, the system memory 810 to the processing unit 804. The processing unit 804 can be any of various available processors. Dual microprocessors and other multiprocessor architectures also can be employed as the processing unit 804.

The system bus 808 can be any of several types of bus structure(s) including the memory bus or memory controller, a peripheral bus or external bus, or a local bus using any variety of available bus architectures including, but not limited to, Controller Area Network (CAN), Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 810 can include volatile memory 810A, non-volatile memory 810B, or both. Operating instructions of a control unit (e.g., control unit 440, etc.) described in the present specification can be loaded into system memory 810, in various embodiments, upon startup of computer 802. The basic input/output system (BIOS), containing the basic routines to transfer information between elements within the computer 802, such as during start-up, is stored in non-volatile memory 810B. In addition, according to present embodiments, codec 814 may include at least one of an encoder or decoder, wherein the at least one of the encoder or decoder may consist of hardware, software, or a combination of hardware and software. Although, codec 814 is depicted as a separate component, codec 814 may be contained within non-volatile memory 810B. By way of illustration, and not limitation, non-volatile memory 810B can include read only memory (ROM), programmable ROM (PROM), electrically programmable ROM (EPROM), electrically erasable programmable ROM (EEPROM), or Flash memory. Non-volatile memory 810B can be embedded memory (e.g., physically integrated with computer 802 or a mainboard thereof), or removable memory. Examples of suitable removable memory can include a secure digital (SD) card, a compact Flash (CF) card, a universal serial bus (USB) memory stick, or the like. Volatile memory 810A includes random access memory (RAM), which can serve as operational system memory for applications executed by processing unit 804. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), and so forth.

Computer 802 may also include removable/non-removable, volatile/non-volatile computer storage medium. FIG. 8 illustrates, for example, disk storage 806. Disk storage 806 includes, but is not limited to, devices such as a magnetic disk drive, solid state disk (SSD) floppy disk drive, tape drive, Flash memory card, memory stick, or the like. In addition, disk storage 806 can include storage medium separately or in combination with other storage medium including, but not limited to, an optical disk drive such as a compact disk ROM device (CD-ROM) or derivative technology (e.g., CD-R Drive, CD-RW Drive, DVD-ROM, and so forth). To facilitate connection of the disk storage 806 to the system bus 808, a removable or non-removable interface is typically used, such as interface 812. In one or more embodiments, disk storage 806 can be limited to solid state non-volatile storage memory, providing motion and vibration resistance for a control unit (e.g., control unit 440, among others) operable in conjunction with an outdoor power equipment (e.g., vehicle 10, etc.).

It is to be appreciated that FIG. 8 describes software stored at non-volatile computer storage media (e.g., disk storage 806) utilized to operate a disclosed control unit 800 to control a motor to adjust steering angle(s) of steerable wheel(s). Such software includes an operating system 806A. Operating system 806A, which can be stored on disk storage 806, acts to control and allocate resources of the computer 802. Applications 806C take advantage of the management of resources by operating system 806A through program modules 806D, and program data 806B, such as the boot/shutdown transaction table and the like, stored either in system memory 810 or on disk storage 806. It is to be appreciated that the claimed subject matter can be implemented with various operating systems or combinations of operating systems.

Input device(s) 842 connects to the processing unit 804 and facilitates user interaction with control unit 800 through the system bus 808 via interface port(s) 830. Input port(s) 840 can include, for example, a serial port, a parallel port, a game port, a universal serial bus (USB), among others. Output device(s) 832 use some of the same type of ports as input device(s) 842. Thus, for example, a USB port may be used to provide input to computer 802 and to output information from computer 802 to an output device 832. Output adapter 830 is provided to illustrate that there are some output devices, such as graphic display, speakers, and printers, among other output devices, which require special adapters. The output adapter 830 can include, by way of illustration and not limitation, video and sound cards that provide a means of connection between the output device 832 and the system bus 808. It should be noted that other devices or systems of devices provide both input and output capabilities such as remote computer(s) 824 and memory storage 826.

Computer 802 can operate in conjunction with one or more electronic devices described herein. For instance, computer 802 can facilitate steering control via a single motor as described herein. Additionally, computer 802 can communicatively couple with a steering motor controller and operator controls, according to one or more aspects discussed herein.

Communication connection(s) 820 refers to the hardware/software employed to connect the network interface 822 to the system bus 808. While communication connection 820 is shown for illustrative clarity inside computer 802, it can also be external to computer 802. The hardware/software necessary for connection to the network interface 822 includes, for exemplary purposes only, internal and external technologies such as, modems including regular telephone grade modems, cable modems and DSL modems, ISDN adapters, and wired and wireless Ethernet cards, hubs, and routers.

Aₛ utilized herein, relative terms or terms of degree such as approximately, substantially or like relative terms such as about, roughly and so forth, are intended to incorporate ranges and variations about a qualified term reasonably encountered by one of ordinary skill in the art in fabricating, compiling or optimizing the embodiments disclosed herein to suit design preferences, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic; e.g., a 0 to five-percent variance or a zero to ten-percent variance from precise mathematically defined value or characteristic, or any suitable value or range there between can define a scope for a disclosed term of degree. Aₛ examples, a steerable wheel can be turned to a disclosed angle, or substantially the disclosed angle, such as the disclosed angle with a variance of 0 to five-percent or 0 to ten-percent; a disclosed mechanical dimension can have a variance of suitable manufacturing tolerances as would be understood by one of ordinary skill in the art, or a variance of a few percent about the disclosed mechanical dimension that would also achieve a stated purpose or function of the disclosed mechanical dimension. These or similar variances can be applicable to other contexts in which a term of degree is utilized herein such as accuracy of measurement of a physical effect (e.g., a motor speed, a wheel angle, etc.) or the like.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

Aₛ used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A vehicle, comprising:
a frame;
two drive elements coupled to the frame, wherein the two drive elements are configured to be driven independently of each other;
steering controls configured to receive an operator input; and
a steering system, comprising:
a first steerable wheel coupled to a first wheel gear and a second steerable wheel coupled to a second wheel gear;
a steering motor controller configured to receive an input signal based at least in part on the operator input and to generate a motor control signal based on the input signal; and
a steering motor configured to rotate a driven steering gear based on the motor control signal, wherein the driven steering gear is mechanically linked to a linked steering gear such that the linked steering gear is configured to rotate with the driven steering gear, wherein the driven steering gear is coupled to the first wheel gear such that rotation of the driven steering gear rotates the first wheel gear and the first steerable wheel to a first angle, and wherein the linked steering gear is coupled to the second wheel gear such that rotation of the linked steering gear rotates the second wheel gear and the second steerable wheel to a second angle.

2. The vehicle of claim 1, wherein the driven steering gear, the linked steering gear, the first wheel gear, and the second wheel gear are non-circular gears.

3. The vehicle of claim 1, wherein, when the first angle and the second angle are non-zero, the first angle is one of greater or lesser than the second angle.

4. The vehicle of claim 3, wherein the combination of the first angle and the second angle provide Ackermann steering for the vehicle.

5. The vehicle of claim 1, wherein the driven steering gear is mechanically linked to the linked steering gear via a panhard bar.

6. The vehicle of claim 1, wherein the input signal is based at least in part on a speed of the vehicle.

7. A steering system, comprising:
a first steerable wheel coupled to a first wheel gear and a second steerable wheel coupled to a second wheel gear;
a steering motor controller configured to receive an input signal based at least in part on an operator input and to generate a motor control signal based on the input signal; and
a steering motor configured to rotate a driven steering gear based on the motor control signal, wherein the driven steering gear is mechanically linked to a linked steering gear such that the linked steering gear is configured to rotate with the driven steering gear, wherein the driven steering gear is coupled to the first wheel gear such that rotation of the driven steering gear rotates the first wheel gear and the first steerable wheel to a first angle, and wherein the linked steering gear is coupled to the second wheel gear such that rotation of the linked steering gear rotates the second wheel gear and the second steerable wheel to a second angle.

8. The steering system of claim 7, wherein the driven steering gear, the linked steering gear, the first wheel gear, and the second wheel gear are non-circular gears.

9. The steering system of claim 7, wherein, when the first angle and the second angle are non-zero, the first angle is one of greater or lesser than the second angle.

10. The steering system of claim 9, wherein the combination of the first angle and the second angle provide Ackermann steering for the vehicle.

11. The steering system of claim 7, wherein the driven steering gear is mechanically linked to the linked steering gear via a panhard bar.

12. The steering system of claim 7, wherein the input signal is based at least in part on a speed of a vehicle employing the steering system.

13. A vehicle, comprising:
a frame defining a first frame side and a second frame side,
a drive wheel
operationally engaged with the frame,
adapted to operationally rotate about a drive axis to cause the vehicle to go into motion,
the drive axis being fixed in orientation with respect to the frame;
a first steerable wheel
steerably engaged to the frame at a first steering axis proximate the first frame side,
the first steering axis being fixed in orientation with respect to the frame,
the first steerable wheel adapted to be operationally steered by being rotated about the first steering axis,
the first steerable wheel adapted to adapted to operationally rotate about a first wheel axis through the center of the first steerable wheel when the vehicle is in motion, and
the first steerable wheel being orientable at some zero angle orientation with respect to the first steering axis, the zero angle orientation being an orientation wherein the first wheel axis is parallel to the drive axis, being orientable at some orientation with respect to the first steering axis to turn in the vehicle toward the first side, and
being orientable at some orientation with respect to the first steering axis to turn in the vehicle toward the second side;
a second steerable wheel
steerably engaged to the frame at a second steering axis 550B proximate the second frame side,
the second steering axis being fixed in orientation with respect to the frame, and
the second steerable wheel adapted to be operationally steered by being rotated about the second steering axis, and
the second steerable wheel
being orientable at some zero angle orientation with respect to the second steering axis, the zero angle orientation being an orientation wherein the second wheel axis is parallel to the drive axis,
being orientable at some orientation with respect to the second steering axis to turn in the vehicle toward the first side, and
being orientable at some orientation with respect to the second steering axis to turn in the vehicle toward the second side;
wherein the second steering axis is offset from the first steering axis by a fixed offset distance W;
a steering motor operationally engaged to rotate simultaneously a first steering gear and a second steering gear based on a motor control signal,
wherein the first steering gear is mechanically linked to the first steerable wheel to cause it to steer as the first steering gear rotates, and
wherein the second steering gear is mechanically linked to the second steerable wheel to cause it to steer as the first steering gear rotates; and
wherein when the first steerable wheel is turned away from the zero angle, the second steerable wheel is also turned away from the zero angle such that both the first wheel axis and the second wheel axis intersect a common axis C that also intersects the drive axis.

14. The vehicle of claim 13, wherein, when the first steerable wheel and the second steerable wheel are oriented to turn the vehicle toward the first side, the angle between the first wheel axis and the zero angle orientation is more than the angle between the second wheel axis and the zero angle orientation.

15. The vehicle of claim 13, wherein, when the first steerable wheel and the second steerable wheel are oriented to turn the vehicle toward the second side, the angle between the second wheel axis and the zero angle orientation is more than the angle between the first wheel axis and the zero angle orientation.

16. The vehicle of claim 13, wherein the first steering gear and a second steering gear have identical shape.

17. The vehicle of claim 13, wherein the first steering gear and a second steering gear are mirror images of each other.

18. The vehicle of claim 13, wherein the first steering gear and a second steering gear are both mechanically linked to the steering motor so that, when rotated by the steering motor, the first steering gear and a second steering gear both rotate simultaneously by the same angular displacement.

19. The vehicle of claim 18, wherein, when rotated by the steering motor, the first steering gear and a second steering gear rotate by the same angular velocity when rotated.

20. The vehicle of claim 19, wherein, when rotated by the steering motor, the angular velocity of the first steerable wheel differs from the angular velocity of the second steering wheel, except when both pass through the zero angle orientation.
